(19) United States
(12) Patent Application Publication
(10) Pub. No.: US 2021/0162874 A1
(43) Pub. Date: Jun. 3, 2021

(54) ENERGY TRANSPORT SYSTEM AND TRANSPORT METHOD THEREOF

(71) Applicant: YOONHEE LEE, McLean, VA (US)

(72) Inventor: YOONHEE LEE, McLean, VA (US)

(21) Appl. No.: 16/942,811

(22) Filed: Jul. 30, 2020

Related U.S. Application Data
(60) Provisional application No. 62/942,162, filed on Dec. 1, 2019.

(51) Int. Cl. B60L 53/00; H02J 7/00; H02J 7/02; H02J 50/10; H02J 50/90; B60L 53/14; B60L 58/12; B60L 53/12

(52) U.S. Cl. CPC B60L 53/00; H02J 7/0045; H02J 7/00045; H02J 7/0048; B60L 53/12; H02J 50/10; H02J 50/90; B60L 53/14; B60L 58/12; H02J 7/02

(57) ABSTRACT

The invention is directed toward charging one or more electric vehicles with an energy transport system. The energy transport system can be integrated with any transportation vehicle such as electric machine, electric robot, electric vehicle, hybrid electric vehicle, or any other vehicle that may include a propulsion power source, such as a battery, ultra-capacitor, or any other energy storage system to mobilize the transportation vehicle. The transportation vehicle may run on one or more energy resources including hydrogen, solar energy, LNG, or a battery stored electrical energy or the like. The transportation vehicle may include Drive control unit, Communication unit, Electric vehicle (EV) charging unit, Energy unit and Power distribution unit.

### TECHNICAL FIELD

The invention provides systems and methods for charging one or more electric vehicles. More specifically, the invention provides for systems and methods for electrically charging one or more electric vehicles.

### BACKGROUND

Over the last decade, there have been major efforts to develop battery-driven electric vehicles for land, sea and air travel. These vehicles are aimed to reduce the pollution from current vehicles, as well as reducing dependence on fossil fuels. Among other things, one problem of current electric vehicles is that their batteries provide limited power for short trips compared to vehicles with combustion engines. Moreover, current battery charging techniques are slow and time-consuming, increasing both the journey time and the dependency on charging stations. Another problem is that the power may be used up in traffic jams, air-conditioning and heating of the vehicle and the actual distance travelable by the vehicle without charging may be significantly less than the original estimate typically less than 200 kilometers for single charge. These disadvantages render electric vehicles impractical and uneconomic. Most of all, building an infrastructure for charging stations presents economical obstacles.

### BRIEF SUMMARY

In accordance with one embodiment, an energy transport system configured to electrically charge one or more electric vehicles is provided. The energy transport system includes a transportation vehicle including any or all of a drive control unit, a communication unit, an electric vehicle (EV) charging unit, an Energy storage unit, and a power distribution unit. The drive control unit is configured to connect with at least to the power distribution unit. In one aspect, the drive control unit may be configured to carry out autonomous driving of the transportation vehicle. The communication unit may be configured at least to connect with the drive control unit, and configured to communicate information with the one or more electric vehicles. The energy storage unit is configured at least electrically connect with any of the power distribution unit and the EV charging unit. The energy storage unit is configured to include one or energy storage modules. In some aspect, the energy storage unit may include a first energy storage module and a second energy storage module.

The first energy storage module is configured to store at least one energy source including any of hydrogen and one or more first electric rechargeable batteries to produce first electric energy. The second energy storage module includes one or more second rechargeable batteries to produce second electric energy. The second energy storage module may be separate from the first energy storage module. In some examples, the second energy storage module, second power distribution and/or the EV charging unit may be configured to detachably connect with the transportation vehicle and/or the energy storage unit. The power distribution unit may be integrated to the transportation vehicle. The power distribution unit is configured at least to connect with the first energy storage module and/or the second energy storage module.

In certain aspect, the power distribution unit may be connected to the first energy storage module, configured to convert at least one energy source to the first electric energy at least in part to power the transportation vehicle for locomotive motion. In another aspect, the power distribution unit may be configured to electrically connect with the EV charging unit. In another aspect, the power distribution unit may be configured to connect with the second energy storage module and provide, at least in part, the first electric energy to the second energy storage module for storage in one or more second rechargeable batteries. The EV charging unit includes an energy transfer unit and is configured to electrically connect with one or more electric vehicles. In various aspects, the EV charging unit may be configured to selectively transfer any of the first electric energy and the second electric energy to the one or more electric vehicles.

### DESCRIPTION OF DRAWINGS

FIG. 1 is a schematic diagram of an exemplary embodiment of the energy transport system 1.

FIG. 2A is a schematic diagram of another exemplary embodiment of the energy transport system 1.

FIG. 2B is a schematic diagram of another exemplary embodiment of the energy transport system 1.

FIG. 2C is a schematic diagram of another exemplary embodiment of the energy transport system 1.

FIG. 3 shows an exemplary configuration of electrical connection among a plurality of transportation vehicles 100 of the energy transport system 1.

FIG. 4 shows an exemplary transportation vehicle 100 of the energy transport system 1.

FIG. 5 shows another exemplary transportation vehicle 100 of the energy transport system 1.

FIG. 6 shows a schematic diagram of another exemplary embodiment of the energy transport system 1.

FIG. 7 shows a schematic diagram of another exemplary embodiment of the energy transport system 1.

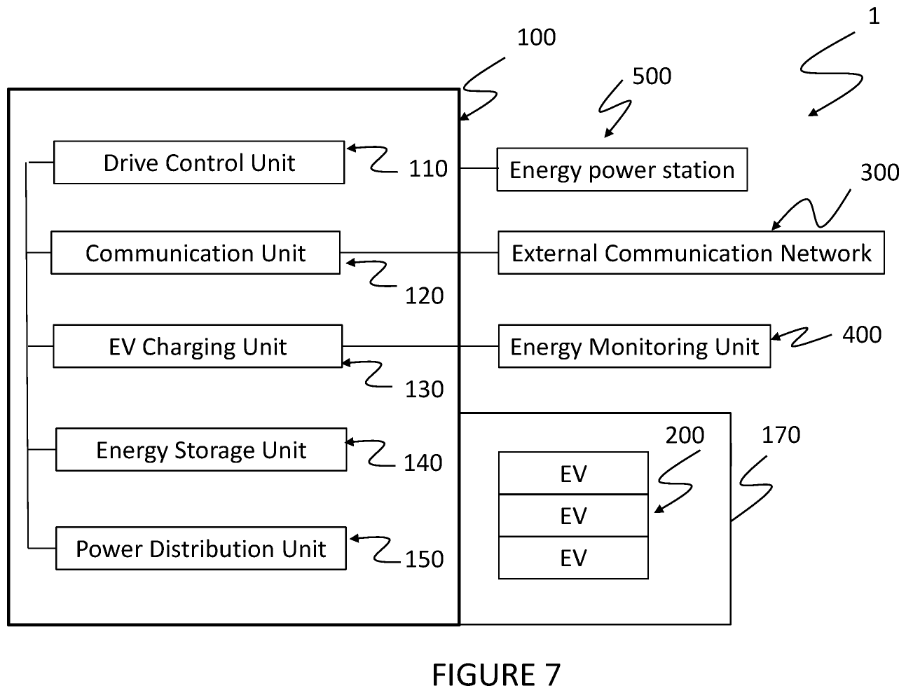

FIG. 8 shows another exemplary transportation vehicle 100 of Energy transport system 1.

FIG. 9 shows an exemplary charging connection between transportation vehicle 100 and a plurality of electric vehicles 200.

FIG. 10 shows another exemplary charging connection between transportation vehicle 100 and a plurality of electric vehicles 200.

### DESCRIPTION

Various embodiments of the present disclosure are disclosed herein. The disclosed embodiments are merely examples that may be embodied in various and alternative forms, and combinations thereof. The following detailed description is merely exemplary in nature and is not intended to limit the application and uses. The word “exemplary” is used exclusively herein to mean “serving as an example, instance, or illustration.” Any embodiment described herein as “exemplary” is not necessarily to be construed as preferred or advantageous over other embodiments. As used herein, for example, “exemplary” and similar terms, refer expansively to embodiments that serve as an illustration, specimen, model or pattern. Furthermore, there is no intention to be bound by any expressed or implied theory presented in the preceding technical field, background, brief summary or the following detailed description.

In the following text, the terms “electric vehicle” and “EV” may be used interchangeably and refer to any of all machines mobilized by electric motor(s) such as robots, bikes, scooters, machinery, cars, drones, airplanes, ships and boats. Similarly, the terms “hybrid”, “hybrid electric vehicle” and “HEV” may be used interchangeably and refer to a vehicle that uses dual propulsion systems, one of which is an electric motor and the other of which may include a combustion engine, hydrogen powered engine, or LNG (Liquified Natural gas) powered engine. Similarly, the terms “battery”, “cell”, and “battery cell” may be used interchangeably and refer to any of a variety of different rechargeable cell chemistries and configurations including, but not limited to, lithium ion (e.g., lithium iron phosphate, lithium cobalt oxide, other lithium metal oxides, etc.), lithium ion polymer, lithium sulfide, sodium based compound, nickel metal hydride, nickel cadmium, nickel hydrogen, nickel zinc, silver zinc, or other battery type/configuration. The term “battery pack” as used herein refers to multiple individual batteries contained within a single piece or multi-piece housing, the individual batteries electrically interconnected to achieve the desired voltage and current capacity for a particular application.

One aspect of the invention provides for connection between Energy transport system 1 and one or more electric loads such as electric vehicles 200. The energy transport system 1 may be used to transfer power to any electric loads such as electric machine, electric robot, electric vehicle, hybrid electric vehicle, or any other vehicle that may include a propulsion power source such as a battery, ultra-capacitor, or any other energy storage system to mobilize the electric-motor driven vehicle 200. In some embodiments, the energy transport system 1 may include any transportation vehicle 100 such as electric machine, electric robot, electric vehicle, hybrid electric vehicle, hydrogen-powered vehicle, solar-powered vehicle or any other vehicle that may include a propulsion power source to mobilize the transportation vehicle 100.

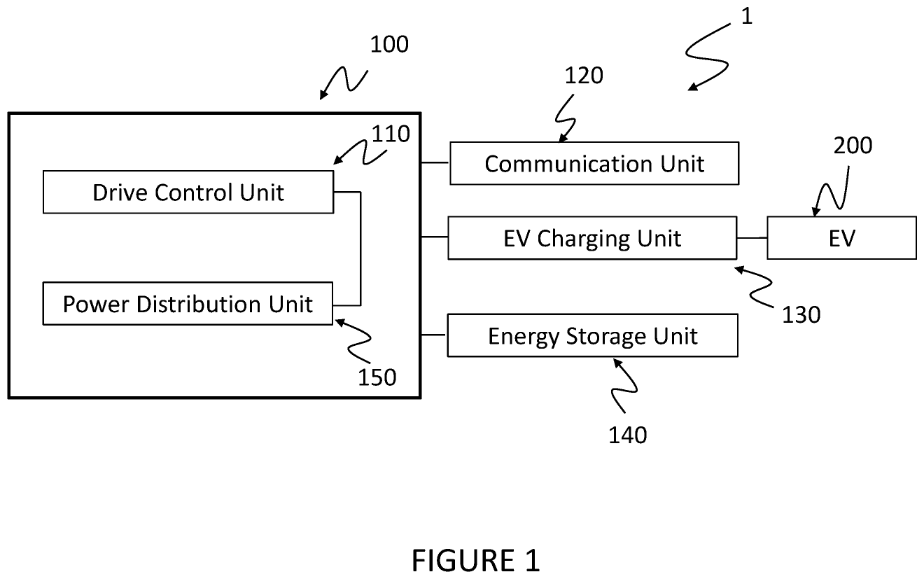

FIG. 1 shows an exemplary embodiment of an energy transport system 1 including Transportation vehicle 100. According to the energy transport system 1 in FIG. 1, the transportation vehicle 100 is used to assist electric vehicles (EV) 200. The transportation vehicle 100 may run on one or more energy resources including hydrogen, solar energy, LNG, or a battery stored electrical energy or the like. The energy transport system 1 may include the transportation vehicle 100 including Drive control unit 110 and Power distribution unit 150. Any of the communication unit 120, electric vehicle (EV) charging unit 130, and energy storage unit 140 may be configured to connect with the transportation vehicle 100.

The power distribution unit 150 is configured to convert one or more energy sources to electric energy or electricity to power the transportation vehicle 100 for locomotive motion and various electric components in the transportation vehicle 100. In some examples, the power distribution unit 150 is coupled to the energy storage unit 140 and includes, among other things, fuses, wiring, and connectors for distributing an energy output from the energy storage unit 140 to various components of the transportation vehicle 100. The power distribution unit 150 is integrated to the transportation vehicle 100. The power distribution unit 150 is communicatively and/or electrically connected to the drive control unit 110. In certain examples, the power distribution unit 150 may be configured to convert the energy source to first electric energy at least in part to power the transportation vehicle 100.

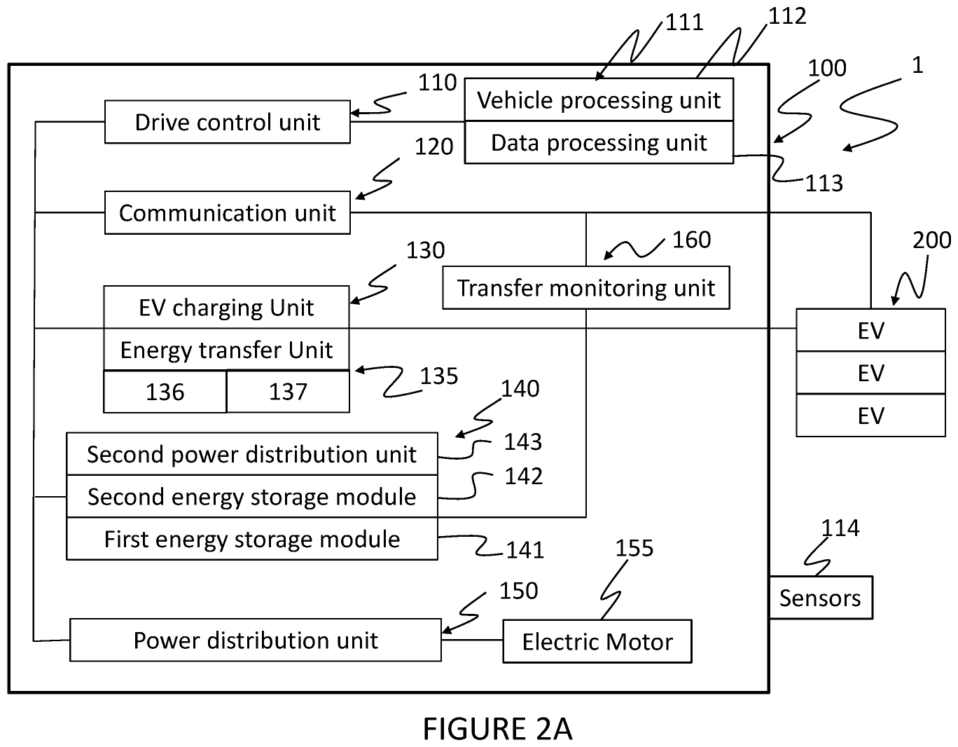

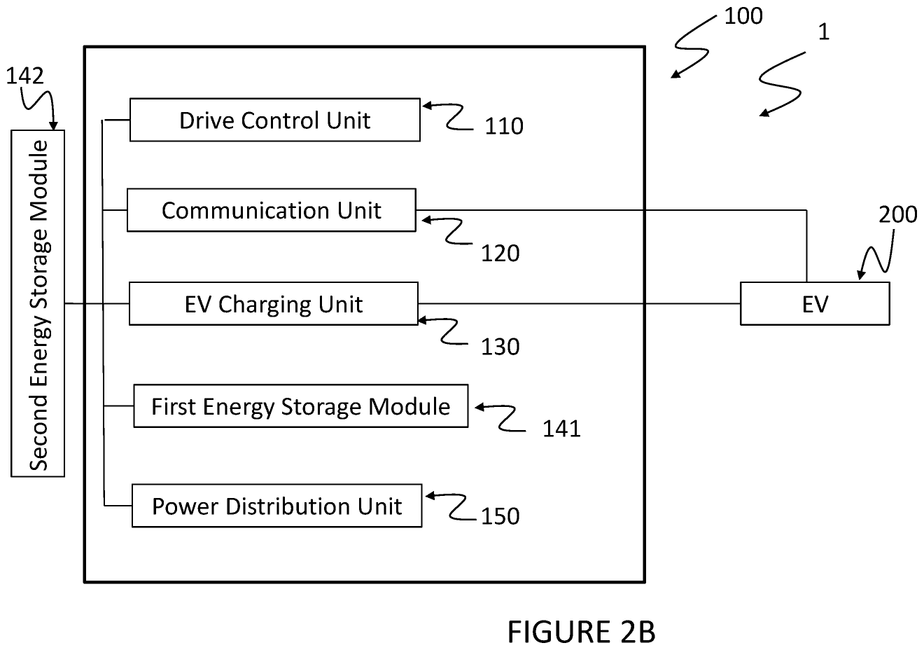

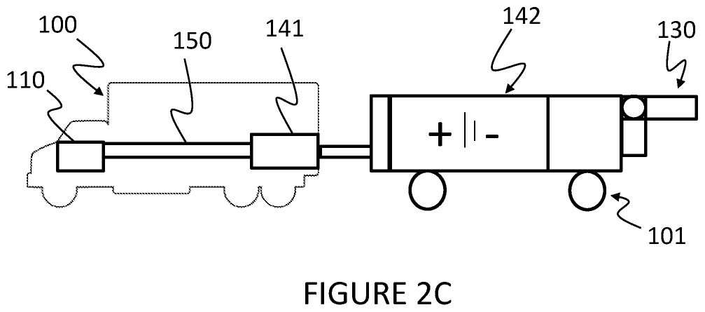

FIG. 2A shows another exemplary embodiment of Energy transport system 1. The power distribution unit 150 is communicatively and electrically connected to electric motor(s) 155 and provides the first electric energy to the electric motor 155 to drive the transportation vehicle 100. The power distribution unit 150 may be configured to convert an energy source to the first electric energy and provide the first electric energy at least in part to an electric energy storage such as a rechargeable battery. In certain aspects, the power distribution unit 150 may be configured to convert an energy source to the first electric energy and provide the first electric energy at least in part to the energy storage unit 140. For example, the power distribution unit 150 may provide the first electric energy to the second energy storage module 142. In various aspects, the power distribution unit 150 may be electrically connected to the EV charging unit 130. In some examples, the power distribution unit 150 may be configured to selectively transfer the first electric energy at least in part to the EV charging unit 130 and/or the energy storage unit 140.

In an exemplary embodiment, the electric vehicle (EV) charging unit 130 and the energy storage unit 140 are connected to the transportation vehicle 100. In some examples, the electric vehicle (EV) charging unit 130, and the energy storage unit 140 may be integrated to the transportation vehicle 100. In certain aspects, the transportation vehicle 100 may include any of Electric vehicle (EV) charging unit 130 and Energy storage unit 140 in modular form. For example, a modular form may include a detachable electric coupling thereby establishing electric connection between two electric units where one end of the coupling is wired to one electric source or load unit and the other end of the coupling is wired to the other electric load or source unit. In certain aspects, the modular features of the energy storage unit 140 may accommodate additional battery modules and thereby increase capacity of the energy storage. The energy storage unit 140 is configured to connect with the power distribution unit 150. The energy storage unit 140 includes an energy storage module containing any of electric battery, battery pack, capacitor or supercapacitor, hydrogen storage, LNG storage, gasoline storage or the like. In certain aspects, the energy storage unit 140 may include a plurality of energy storage modules where each of the energy storage modules include one or more of electric battery, battery pack, capacitor or supercapacitor, hydrogen storage, LNG storage, gasoline storage or the like. For example, the energy storage unit 140 may include First energy storage module 141 and Second energy storage module 142. The first energy storage module 141 is configured to accommodate and/or store one or more of electric battery, battery pack, capacitor or supercapacitor, hydrogen storage, LNG storage, gasoline storage or the like. In some examples, the first energy storage module 141 may be configured to store at least one energy source including any of hydrogen and one or more first electric rechargeable batteries to produce first electric energy. In some examples, the first energy storage module 141 may be configured to receive hydrogen as energy source from external charging station 500. In another example, the first energy storage module 141 may be configured to receive hydrogen as energy source from external charging station 500 whereas the second energy storage module 142 may be configured to receive electricity as energy source to recharge rechargeable batteries from external charging station 500. In some aspects, the EV charging unit 130 may be configured to detachably connect with the transportation vehicle 100. In another aspect, the EV charging unit 130 may be configured to be separate from but to detachably connect with the energy storage unit 140. In another aspect, the EV charging unit 130 may be configured to detachably connect with any of the first energy storage module 141 and the second energy storage module 142. In another aspect the EV charging unit 130 may be configured to detachably incorporate and/or connect with one or more replaceable and/or detachable electric plugs so that the EV charging unit 130 can connect with and charge various types of electric vehicles 200 having different types of electric adaptors.

The second energy storage module 142 includes one or more second rechargeable battery batteries to produce additional/second electric energy to charge one or more electric vehicles 200. In some examples, the one or more second rechargeable batteries may be in a form of battery pack. In certain aspects, the second energy storage module 142 may be configured to replace/swap one or more second rechargeable batteries with other or new rechargeable batteries. For example, the second energy storage module 142 may be configured to swap one or more second rechargeable batteries with one or more rechargeable batteries of the electric vehicle 200. The second energy storage module 142 may be configured to connect with second power distribution unit 143. The second power distribution unit 143 is configured to convert an energy source stored in the second energy storage module 142 to second electric energy. The second power distribution unit 143 is configured to connect with the EV charging unit 130 to provide the second electric energy. In another embodiment, the second energy storage module 142 may be configured to detachably connect with the transportation vehicle 100 and/or the EV charging unit 130 as shown in FIG. 2B. In some cases, the second energy storage module 142 and optionally the power distribution unit 130 may include a transportation means such as wheels, roller balls, wings, fins or the likes, which is separate from the transportation vehicle 100 where the transportation means 101 is separate from the transportation vehicle 100 so that any of the second energy storage module 142 and the EV charging unit 130 can be transportable while being connected to and driven by the transportation vehicle 100 as in FIG. 2A.

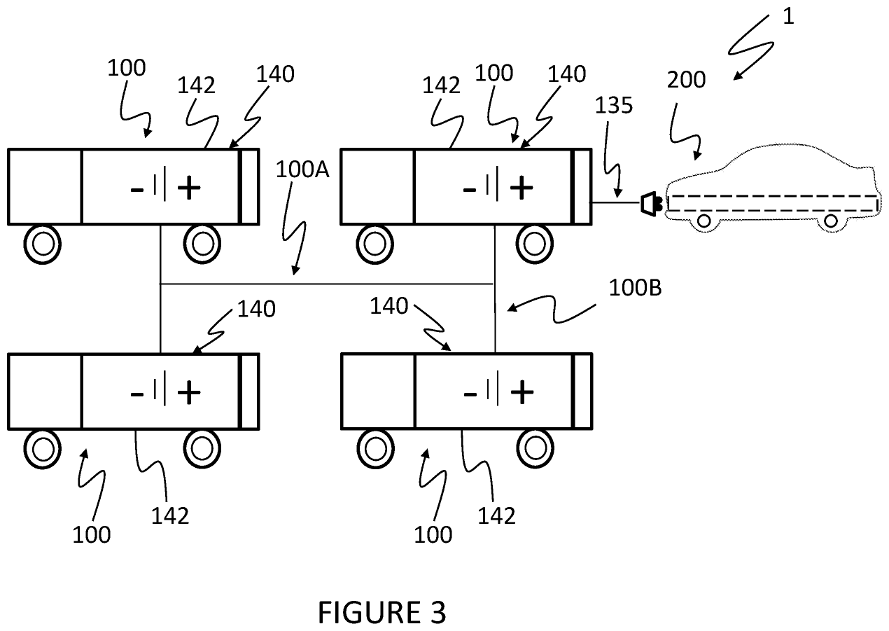

FIG. 3 shows an exemplary configuration of electrical connection among a plurality of transportation vehicles 100. The energy transfer system 1 may include a plurality of transportation vehicles 100. The energy storage units 140 among a plurality of transportation vehicles 100 may be configured to establish electrical connection for energy transfer among the transportation vehicles 100 in series 100A, in parallel 100B or in a combination thereof. FIG. 3 shows symbolic current signs to represent the overall battery arrangements and connections among the transportation vehicles 100. In certain aspects, the second energy storage modules 142 may be configured to establish electrical connection for energy transfer among the transportation vehicles 100. For example, the second energy storage modules 142 including the one or more second rechargeable batteries may connect with one or more second rechargeable batteries in separate second energy storage modules 142 in series 100A or in parallel 100B or in a combination thereof. Such collective formation of battery connections in series, parallel or both can increase the overall energy transfer capacity to charge electric vehicle 200 and achieve faster charging time. The energy transfer unit 135 in at least one of the transportation vehicles 100 may be configured to carry out the energy transfer from the collective formation of battery connections. In some examples, the energy storage unit 140 may be configured for bidirectional energy conversion. For example, any of the energy transfer unit 135, the EV charging unit 130, and the energy storage unit 140 may be connected to a bidirectional converter and charge controller for controlling current being communicated among the transportation vehicles 100 in the collective formation.

In an exemplary embodiment, the transportation vehicle 100 may be a fuel cell vehicle or electric hybrid vehicle. For example, the first energy storage module 141 in FIG. 2 may be configured to store hydrogen. In some examples, the power distribution unit 150 may be configured to convert hydrogen provided by the first energy storage module 141 to first electric energy at least in part to power the transportation vehicle 100. The power distribution unit 150 for hydrogen conversion may include a fuel cell, an electric power supplying device configured to supply electric power (electricity) to a load from the fuel cell. In certain aspects, the power distribution unit 150 may provide the first electric energy converted from hydrogen at least in part to the second energy storage module 142 in the energy storage unit 140. In another aspect, the power distribution unit 150 may provide the first electric energy converted from hydrogen at least in part to the EV charging unit 130.

In another embodiment, the transportation vehicle 100 may be an electric vehicle, using electric energy stored in one or more rechargeable batteries as a main energy source to power the transportation vehicle 100 for driving/locomotive motion where the one or more rechargeable batteries are mounted on the energy storage unit 140. The one or more rechargeable batteries may be in a form of battery pack. In certain aspects, the first energy storage module 141 in FIG. 2 may include the one or more rechargeable batteries as a main energy source for driving. In another aspect, the first energy storage module 141 may further include a sub-rechargeable battery detachably connected to the energy storage unit 140. For example, Electric motor 155 mobilizing the transportation vehicle 100 may be driven by the main energy source and the sub-battery, thereby to generate a traveling drive force and which generates a regenerative brake force at deceleration of the vehicle body. When the sub-rechargeable battery is connected to the power distribution unit 150, the drive control unit 110 and the power distribution unit 150 may be configured to selectively control the electric motor 155 so that the electric motor 155 uses an electric power of the main energy source for driving the transportation vehicle 100 and the motor 155 charges via the power distribution unit 150 the sub-rechargeable battery by a regenerative power generated by the electric motor 155. In some aspects, the sub-rechargeable battery may be placed in the second energy storage module 142.

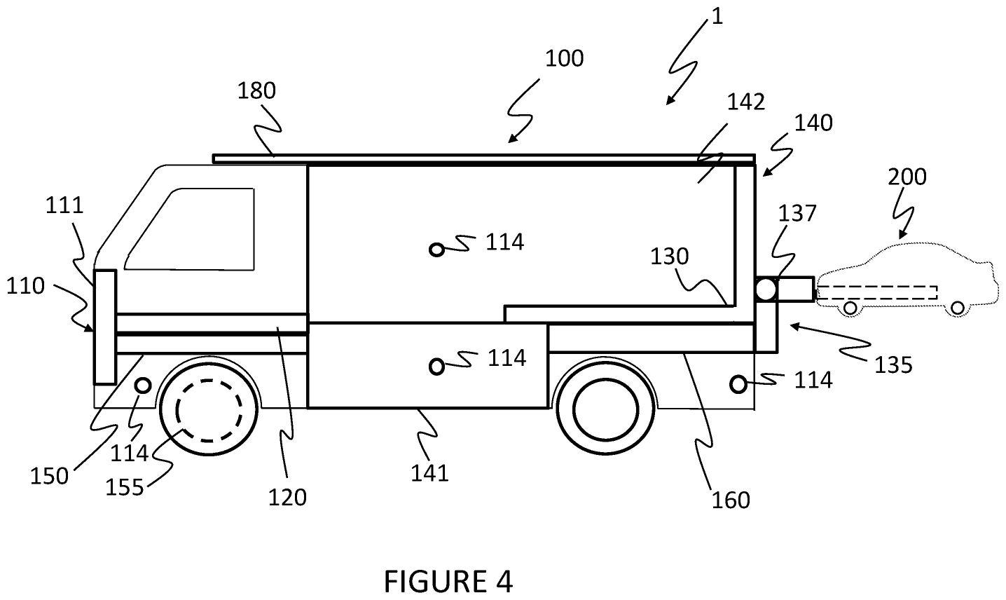

In another embodiment as in FIG. 4, the transportation vehicle 100 may include vehicular solar panel 180. The vehicular solar panel or panels 180 may be at any exterior location on the transportation vehicle 100 which is exposed to solar energy, including but not limited to the locations of the body panels. Each of the vehicular solar panels 180 provided on the transportation vehicle 100 is electrically connected to the power distribution unit 150 and/or the energy storage unit 140. In some examples, one or more of the vehicular solar panels 180 may be connected to the power distribution unit 150. For example, in use of the vehicular solar panels 180, each vehicular solar panel 180 is capable of capturing solar energy and converting the solar energy into electrical energy for powering of various electrical components of the transportation vehicle 100. In one aspect, the vehicular solar panel or panels 180 may function as an APU (ancillary power unit) for the transportation vehicle 100. Each vehicular solar panel is capable of collecting energy from ambient light and diffuse light under a cloud cover, as well as direct sunlight. In certain aspects, one or more solar panels 180 on the transportation vehicle 100 may be any type of solar panel or material which is capable of capturing solar energy and converting the solar energy into electrical energy. For example, the vehicular solar panel 180 may be a solar fabric panel. Industrial processes which are well-known to those skilled in the art may be used to fabricate the vehicular solar panel in the form of a solar fabric panel.

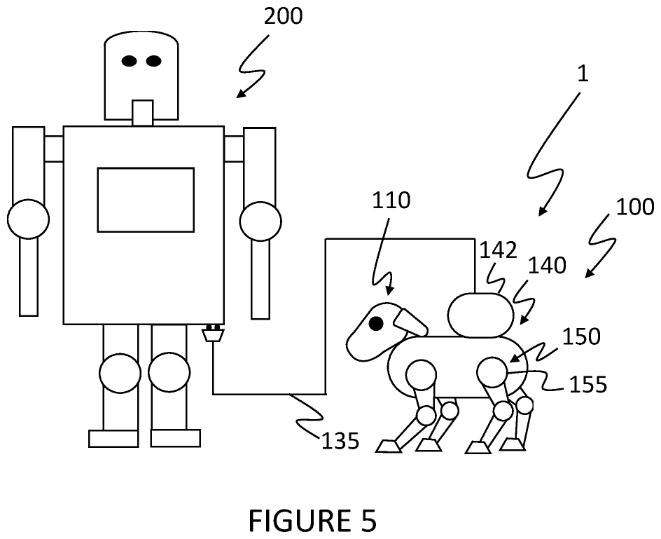

The EV charging unit 130 is configured to process output and/or input electric energy from the energy storage unit 140 and the power distribution unit 150 to input electric energy suitable for provision to at least one battery. In various aspects, the EV charging unit 130 may process second electric energy provided by the energy storage unit 140. The EV charging unit 130 includes energy transfer unit 135, as shown in FIG. 2, adapted to transfer any of the first electric energy and the second electric from the energy storage unit 140 and/or the power distribution unit 150 to one or more of the electric vehicles 200. In some examples, the energy transfer unit 135 may be configured to electrically connect with a plurality of electric vehicles 200 and selectively transfer the second electric energy to the plurality of electric vehicles 200. In another example, the energy transfer unit 135 may be configured to electrically connect with a plurality of electric vehicles 200 and selectively transfer any of the first electric energy and the second electric energy to one or more of electric vehicles 200. The electric vehicle 200 may be in a form of locomotive machine such as a bike, scooter, car, and truck, robot, a flying vehicle, drone and a boat. FIG. 5 illustrates electrical connections between transportation vehicle 100 (a mobilized machine not showing the detailed inside for clarity purposes) and electric vehicle 200 (a mobilized machine having electric motor).

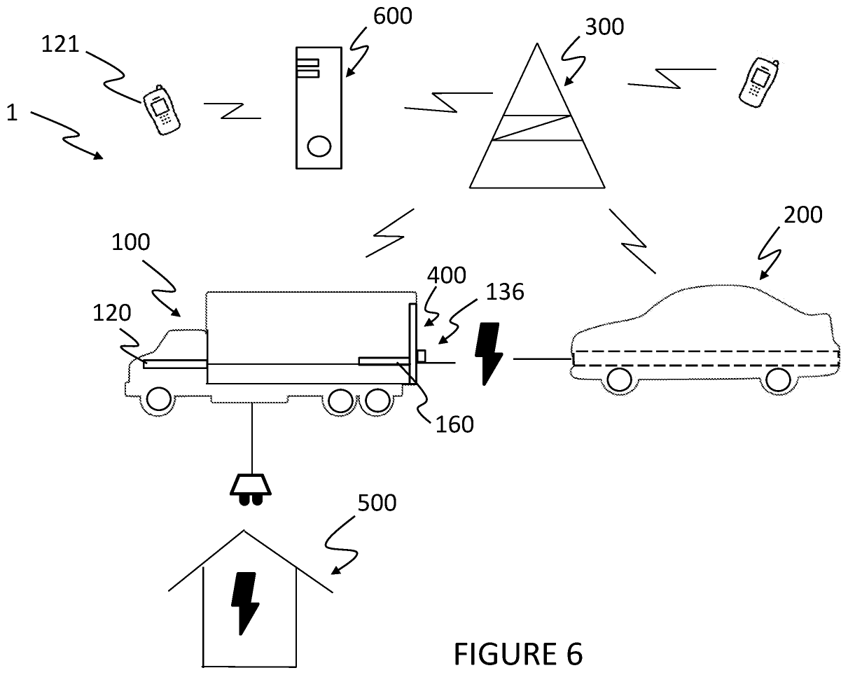

The energy transfer unit 135 is configured to electrically connect with the one or more electric vehicles 200 including any of an electric land vehicle, an electric aerial vehicle and/or an electric water vehicle. In some examples, the energy transfer unit 135 may be configured to establish electrical contact with the electrical vehicle(s) 200 in manual manner. In another example, the energy transfer unit 135 may be configured to establish electrical contact with the electrical vehicle(s) 200 in autonomous manner. For example, the energy transfer unit 135 may include wireless energy transfer unit 136 configured to carry out wireless energy transfer to the one or more electric vehicles 200 as in FIG. 6. In another example, the energy transfer unit 135 may be equipped with robotic arm 137. The robotic arm 137, as illustrated in FIG. 4, is configured to establish electrical contact with the one or more electric vehicles 200 for energy transfer. In various aspects, the robotic arm 137 is configured to establish electrical contact with the one or more electric vehicles 200 for energy transfer in autonomous manner. In another aspect, the energy transfer unit 130 may include a plurality of robotic arms 137. In some examples, the energy transfer unit 130 may establish electric contact with a plurality of electric vehicles 200 for energy transfer in sequence.

In accordance with an aspect of the present embodiment as in FIG. 2A, the transportation vehicle 100 may further include transfer monitoring unit 160. The transfer monitoring unit 160 is configured to manage or control an electric power demand from one or more electric vehicles (EV) 200. Once the transfer monitoring unit 160 has identified an electric vehicle 200 in need of electric charging, the transfer monitoring unit 160 can process data that includes a vehicle identifier identifying any of the transportation vehicle 100 and the electric vehicle(s) 200. The transfer monitoring unit 160 may process electric charge demand requested by one or more electric vehicles 200. For example, the demand information may include any of a vehicle identifier of the transportation vehicle 100, a vehicle identifier of the electric vehicle 200, a pre-determined charge state of the electric vehicle 200, a location of the transportation vehicle 100, a location of the electric vehicle 200, a distance from the location of the transportation vehicle 100 to the location of the electric vehicle 200, a desired route to the electric vehicle 200 from the transportation vehicle 100, a desired route to the transportation vehicle 100 from the electric vehicle 200, an actual charge state of the electric vehicle 200, a demanded amount of electric energy for charging, a duration time for charging to fulfill the demanded amount of electric energy; an appointed time for charging, a type of available charging method of the transportation vehicle 100, a destination for charging, and/or a desired charging/supply price. In some aspects, the transfer monitoring unit 160 may manage supply information of the transportation vehicle 100 by surveying available electric supply, a charging/supply price, a time and/or destination for electric charging. The transfer monitoring unit 160 may be configured to determine, prioritize, and/or process an electric charging sequence, location and/or time for electric charging based on the communication with the electric vehicle 200 via the communication unit 120. The transfer monitoring unit 160 may be configured to manage demand information of a plurality of electric vehicles (EV) 200.

In an embodiment according to the disclosure as in FIG. 2A, the communication unit 120 is configured to communicatively connect with any of the drive control unit 110, the EV charging unit 130, the energy storage unit 140 and/or the power distribution unit 150. In some aspects, the communication unit 120 is configured to communicatively connect with the transfer monitoring unit 160, and configured to receive and process any of the demand information from one or more electric vehicles 200 for the transfer monitoring unit 160 to process. The communication unit 120 may be communicatively connected to the drive control unit 110. The demand information may also include any of brand preference, price sensitivity, time sensitivity, and/or electric charging connectivity. For example, the communication unit 120 may receive information about the electric vehicle 200 such as the brand of the electric vehicle 200, the price sensitivity, time sensitivity, electric charging type, electric charging status, and/or destination information, the projected route, and roads. The communication unit 120 may receive and/or determine one or more charging destinations within the driving range of the electric vehicle 200 and/or transportation vehicle 100. The range can be based on the available electric charge in the electric vehicle 200 and/or the transportation vehicle 100. In some examples, the range can be based on a configurable distance from the projected route. In a configuration, the communication unit 120 may determine a single preferred electric charging location for one or more electric vehicles 200. In another configuration, the communication unit 120 may process and determine more than one preferred charging locations. In some configurations, the communication unit 120 may determine an electric charging location for each of one or more electric vehicles 200.

In an exemplary embodiment as shown in FIG. 6, the communication unit 120 may be configured to connect with External communication network 300 such as a mobile network. In some examples, the external communication network 300 may relay any of the demand information from the one or more electric vehicles 200 to the communication unit 120. The external communication network 300 may utilize a network of satellites in a global positioning system such as GPS, GLONASS, Galieo, or the likes, a network of beacons in a local positioning system such as ultrasonic positioning, laser position, or the likes, a network of Wi-Fi base stations, or any combination thereof. In some examples, the communication unit 120 may utilize a network of satellites in a global positioning system such as GPS, GLONASS, Galieo, or the likes, a network of beacons in a local positioning system such as ultrasonic positioning, laser position, or the likes, a network of Wi-Fi base stations, or any combination thereof. For example, the communication unit 120 may also use a third party service such as Google™, Waze™, Apple™ maps or the likes to receive and/or process any of the demand information.

In some cases, the energy transfer system 1 may include External control center 600 as in FIG. 6. The external control center 600 may be communicatively connected to the external communication network 300. The external control center 600 is configured to process demand information from the electric vehicle 200 and any information from the communication unit 120. In certain aspects, the external control center 600 may be communicatively connected to the drive control unit 110, and/or communication unit 120 to obtain and process any information about the transportation vehicle 100. For example, the external control center 600 may direct the transportation vehicle 100 for the locomotive motion and energy transfer via the communication unit 120 and the drive control unit 110 and subsequently the EV charging unit 130.

The drive control unit 110 is connected to the transportation vehicle 100 and configured to carry out any of manned or unmanned autonomous driving of the transportation vehicle 100 during the locomotive motion as in FIG. 2. The drive control unit 110 is communicatively connected to the communication unit 120. In another aspect, the drive control unit 110 is communicatively and/or electrically connected to transfer monitoring unit 160. In some examples, the drive control unit 110 may be configured to communicatively, electrically, and/or mechanically connect with any unit of the transportation vehicle 100. In certain examples, the drive control unit 110 may be configured to communicatively and electrically connect with any or all of the communication unit 120, the EV charging unit 130, the energy storage unit 140, and the power distribution unit 150, and transfer monitoring unit 160.

In an exemplary embodiment, the drive control unit 110 includes On-board computer 111 equipped with an autonomous driving system including any of driver assistance, partial automation, conditional automation, high automation and full automation according to National Highway Traffic Safety Administration of United States. The on-board computer 111 may include Vehicle processing unit 112 and Data processing unit 113. The vehicle processing unit 112 is communicatively connected to one or more sensors 114 installed in the transportation vehicle 100. The vehicle processing unit 112 is configured to process information regarding the transportation vehicle 100 such as robot, car, truck, bus, drone and boat. The vehicle processing unit 112 is also configured to process the surrounding conditions of the transportation vehicle 100. In certain aspects, the sensors 114 may be utilized to obtain information of the transportation vehicle 100 and the surrounding conditions including information about the electric vehicle or vehicles 200.

The on-board computer 111 may process information from the communication unit 120, information from the vehicle processing unit 112, or both to operate the transportation vehicle 100 for autonomous driving operation or to assist a vehicle operator/driver in operating the transportation vehicle 100 at least in part in autonomous manner. In some examples, the on-board computer 111 may process information from the vehicle processing unit 112 to operate the transportation vehicle 100 for autonomous driving operation or to assist a vehicle operator in operating the transportation vehicle 100 at least in part in autonomous manner. In certain examples, the drive control unit 110 may carry out partial, high or full autonomous driving of the transportation vehicle 100 for electrical contact with the electric vehicle 200 for charging once a physical distance between the transportation vehicle 100 and the electric vehicle 200 is at or less than a pre-determined distance. In certain aspects, the pre-determined distance may be a detectable range of the sensors 114. In another aspect, the pre-determined distance may be 100 feet or less. In another aspect, the pre-determined distance may be 50 feet or less. In another aspect, the pre-determined distance may be 10 feet or less.

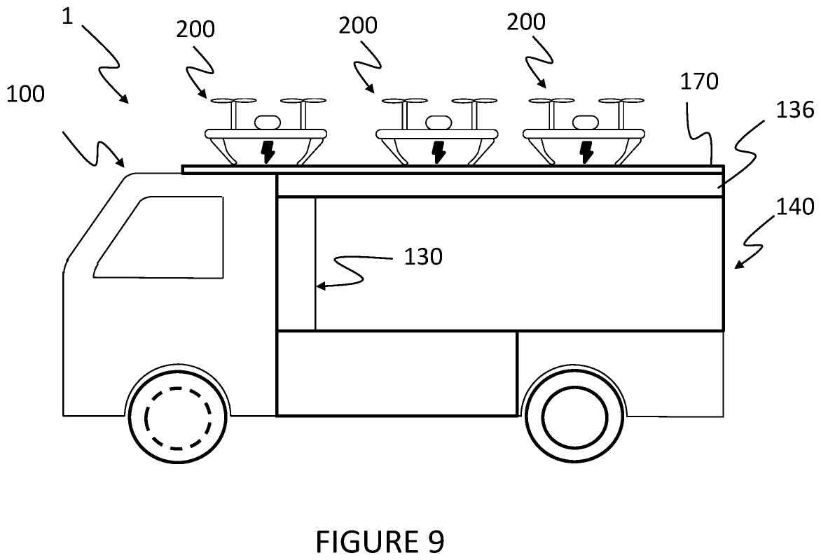

In another exemplary embodiment, the energy transport system 1 includes Docking unit 170 to accommodate the electric vehicle 200 for charging of on-board vehicle batteries. FIG. 9 shows a transportation vehicle 100 including the docking unit 170. In some examples, the docking unit 170 may be configured to accommodate a plurality of electric vehicles 200. In certain aspect, the docking unit 170 is configured to electrically connect with the EV charging unit 130 so that the electric vehicles 200 in the docking unit 170 can be charged via the EV charging unit 130. In some examples, the docking unit 170 may be directly placed on the transportation vehicle 100. In another aspect, the docking unit 170 is placed within the transportation vehicle 100. In another aspect, the docking unit 170 is mechanically connected to the transportation vehicle 100. FIG. 9 illustrates a transportation vehicle 100 equipped with a docking unit 170 where a plurality of drones 200 are being wireless charged on the docking unit 170.

In another exemplary embodiment, the energy transport system 1 includes Energy monitoring unit 400 as shown in FIG. 6. The energy monitoring unit 400 is configured to monitor available energy in the first energy storage unit 141 and a charge state of any of rechargeable batteries in energy storage unit 140. The energy monitoring unit 400 may be directly connected to the transportation vehicle 100. In some examples, the energy monitoring unit 400 may be communicatively connected to any of the communication unit 120 and/or the drive control unit 110 to monitor the energy level in the energy storage unit 140. If any of the available energy or the charge state is below a pre-determined minimum level, the energy monitoring unit 400 may communicatively alert a driver of the transportation vehicle 100 via the communication unit 120. In some examples, the energy monitoring unit 400 may direct the drive control unit 110 to autonomously drive the transportation vehicle 100 to another transportation vehicle 100 or an external charging station 500 as illustrated in FIG. 6. The charging station 500 may supply any of gasoline, hydrogen, LNG (Liquified Natural gas), electricity.

### INDUSTRIAL APPLICABILITY

The detailed description provides those skilled in the art with a convenient road map for implementing the exemplary embodiment or exemplary embodiments. Many modifications and variations will be apparent to those of ordinary skill in the art without departing from the scope and spirit of the invention. For example, although the description above describes specific implementations of the disclosed embodiments that are used in conjunction with electric vehicles, other implementations are possible in which the energy transfer system can be used with various types of vehicles.

The processes described herein can be executed by programmable equipment, such as computers or computer systems and/or processors. Software that can cause programmable equipment to execute processes can be stored in any storage device. The computing device can be integrated with or incorporated into a programmable processor/processors of the transportation vehicle 100, including vehicle electronics, or a server. The computing device can be any suitable computing device as would be understood in the art, including without limitation, a custom chip, an embedded processing device, a tablet computing device, a personal data assistant (PDA), a cellular phone, a desktop, a laptop, a microcomputer, a minicomputer, a server, a mainframe, or any other suitable programmable device, which can be communicatively connected to the transportation vehicle 100. In various embodiments disclosed herein, a single component can be replaced by multiple components and multiple components can be replaced by a single component to perform a given function or functions. Except where such substitution would not be operative, such substitution is within the intended scope of the embodiments.

The drive control unit 110 is configured to control switching between manual driving and autonomous driving of the transportation vehicle 100. In some examples, the drive control unit 110 is configured to perform fully autonomous driving of the transportation vehicle 100. In another example, the drive control unit 110 is configured to perform fully unmanned autonomous driving of the transportation vehicle 100. During autonomous driving, the drive control unit 110 is configured to perform at least autonomous driving control such as the lane keeping assist control and the cruise control based on information obtained from the vehicle sensors 114.

The on-board computer 111 as described in FIG. 2A may include a computing device that can be any suitable type of processing unit, for example a general purpose central processing unit (CPU), a reduced instruction set computer (RISC), a processor that has a pipeline or multiple processing capability including having multiple cores, a complex instruction set computer (CISC), a digital signal processor (DSP), an application specific integrated circuits (ASIC), a programmable logic devices (PLD), and a field programmable gate array (FPGA), among others. The computing resources can also include distributed computing devices, cloud computing resources, and virtual computing resources in general.

Vehicle processing unit 112 may be disposed within or communicatively connected to the on-board computer 111, which may be permanently or in a replaceable form installed in the transportation vehicle 100. The on-board computer 111 may interface with the one or more vehicle sensors 114 within the transportation vehicle 100 such as a digital camera, a LIDAR sensor (LIDAR may use ultraviolet, visible, or near infrared light to image objects), an ultrasonic sensor, an infrared sensor, a laser sensor, an ignition sensor, an odometer, a system clock, a speedometer, a tachometer, an accelerometer, a gyroscope, a compass, a geolocation unit, electric potential measuring sensor, voltage measuring sensor, current measuring sensor, chemical sensor, and/or radar unit., The vehicle sensors 114 also include sensors for driving. For example, the vehicle sensors 114 may include steering sensor to measure a steering angle, a steering torque sensor, a vehicle acceleration pedal sensor and a vehicle brake pedal sensor. The vehicle sensors 114 may also be incorporated within or communicatively connected to any of communication unit 120, EV charging unit 130, energy storage unit 140, power distribution unit 150 and transfer monitoring unit 160.

Data processing unit 113 is configured to store and process any data obtained by various units of the energy transport system 1. includes one or more memories, for example read only memory (ROM), random access memory (RAM), cache memory associated with the processor, or other memories such as dynamic RAM (DRAM), static ram (SRAM), programmable ROM (PROM), electrically erasable PROM (EEPROM), flash memory, a removable memory card or disk, a solid state drive, and so forth. The computing device in Data processing unit 113 also includes storage media such as a storage device that can be configured to have multiple modules, such as magnetic disk drives, floppy drives, tape drives, hard drives, optical drives and media, magneto-optical drives and media, compact disk drives, Compact Disk Read Only Memory (CD-ROM), Compact Disk Recordable (CD-R), Compact Disk Rewriteable (CD-RW), a suitable type of Digital Versatile Disk (DVD) or BluRay disk, and so forth. Storage media such as flash drives, solid state hard drives, redundant array of individual disks (RAID), virtual drives, networked drives and other memory means including storage media on the processor, or memories are also contemplated as storage devices. It can be appreciated that such memory can be internal or external with respect to operation of the disclosed embodiments. It can be appreciated that certain portions of the processes described herein can be performed using instructions stored on a computer-readable medium or media that direct a computer system to perform the process steps. Non-transitory computer-readable media, as used herein, comprises all computer-readable media except for transitory, propagating signals.

In certain aspect, any of the communication unit 120, electric vehicle (EV) charging unit 130, and energy storage unit 140 may be configured to detachably and/or directly connect with the transportation vehicle 100. In various aspects, any of the communication unit 120, electric vehicle (EV) charging unit 130, and energy storage unit 140 may be in a modular form to detachably and/or directly connect with the transportation vehicle 100. In another aspect, any of the communication unit 120, electric vehicle (EV) charging unit 130, and energy storage unit 140 may be integrated with the transportation vehicle 100.

In a configuration, the communication unit 120 is configured to transmit and/or receive communication signals, the communication signals being any or any combination of global positioning satellite (GPS) signals, radio frequency identification (RFID) signals, infrared radiation (IR) signals, Bluetooth signals and near field communication (NFC) signals, radio frequency signals in a range of from 300 Hz to 300 GHz. The communication unit 120 may include vehicle electronics configured to transmit and receive vehicle data collected from vehicle sensors 114 using a vehicle network. An example vehicle network is a vehicle controller area network (CAN). Example vehicle data is CAN data. The vehicle data can include speed, position, charge level, blinker activation, and other sensor data. The vehicle electronics can include a global positioning system (GPS) receiver. A transceiver can be connected to the vehicle network to enable communications with other devices. The transceiver can use one or more wireless technologies including but not limited to WiFi™, Bluetooth™, ZigBee™, one of the IEEE 802.11x family of network protocols, a cellular protocol, or another suitable wireless network protocol, or wired technologies, such as the Universal Serial Bus (USB) protocol. In some examples, a mobile computing device 121 communicatively linked to the communication unit 120 can establish a wireless communication link with the one or more electric vehicles to process the vehicle and/or demand information.

The EV charging unit 130 may be equipped with power converter including any of linear regulator, voltage regulator, motor-generator, rotary converter, and switched-mode power supply. In some examples, the EV charging unit 130 may be connected to any of rectifier, mains power supply unit (PSU), DC-AC power inverter, DC-DC power inverter, autotransformer, voltage converter, voltage regulator, cycloconverter, and variable-frequency transformer. In certain aspects, the EV charging unit 130 may be connected to a bidirectional power converter for any of AC-DC or DC-DC to control the power flow between input and output power sources. In many cases, those power converters are in form of circuitry system. In various examples, the power distribution unit 150, the energy storage unit 140, the EV charging unit 130 may be configured to control and regulate any of the first electric energy and the second electric energy via one or more power converters in the transportation vehicle 100. In some cases, the energy storage unit 140 and optionally the EV charging unit 130 may be detachably connected to the transportation vehicle 100. In certain aspect, any of the energy storage unit 140 and the EV charging unit 130 may include a transportation means 101 such as wheels, roller balls, wings, fins or the likes.

For wireless charging, the wireless energy transfer unit 136 may include an on-vehicle inductive coil disposed on the transportation vehicle 100, and be configured to transmit at least a portion of the first energy and/or second energy wirelessly to an inductive coil of the electric vehicle 200. The wireless energy transfer unit 136 may further include an electrical signal shaping device in electrical communication with the on-vehicle inductive coil to electrically charge the battery, and an alignment means for positioning the transportation vehicle 100 relative to the inductive coil of the electric vehicle 200 so that the on-vehicle inductive coil of the transportation vehicle 100 is aligned with the inductive coil of the electric vehicle 200. In some examples, the alignment may be done autonomously. In certain aspects, the alignment for any of the wireless charging or wire charging may be carried out in autonomous driving. In some examples, the energy transfer unit 135 may be configured to receive electric energy wirelessly transmitted from the off-vehicle inductive coil of an electric charge station 500. The received electric energy may be provided to any of the first energy storage module 141 and the second energy storage module 142 to recharge one or more rechargeable batteries therein.

In an exemplary embodiment, predefined criteria relating to energy transfer can include authorization to perform the power transfer when the electric vehicle 200 is electrically connected to the transportation vehicle 100. In some examples, the authorization may include authorization to operate such as access and move the electric vehicle 200 upon the connection. In some embodiments, the predefined criteria for the authorization can also relate to the demand information. For example, the predefined criteria relating to disconnecting from the electric vehicle 200 can be that the electric vehicle 200 is within a certain percentage of being fully charged, for example 70% charge or higher in the SoC, and/or that the electric vehicle 200 has been connected to the transportation vehicle 100 for a period greater than or equal to a predetermined duration, and/or that the electric vehicle 200 has not been disconnected from the transportation vehicle 100 for a period greater than or equal to another predetermined duration. Inversely, the predefined criteria relating to prioritizing the charging sequence of a plurality of the electric vehicles 200 can be that the electric vehicle 200 is within a certain percentage of being discharged, for example 80% or higher in the DoD. In some embodiments, the predefined criteria can also relate to recent movement status of the electric vehicle 200 after authentication.

The energy storage unit 140 may include at least one measurement arrangement configured to take measurements from any or each of rechargeable batteries in the first storage module 141 and the second energy storage module 142. The measurements include a condition of a rechargeable battery including State of Charge (SoC) and Depth of Discharge (DoD) values. The State of charge (SoC) is the level of charge of an electric battery relative to its capacity. The units of SoC are percentage points (0%=empty; 100%=full). An alternative form of the same measure is the depth of discharge (DoD), the inverse of SoC (100%=empty; 0%=full). The energy storage unit 140 may be communicatively connected to the energy monitoring unit 400 to communicate the measurement values. In some examples, the first energy storage module 141 and the second energy storage module 142 may be configured to accommodate any of high-powered (high output density type) battery and high-capacity (high energy density type) battery. In certain aspects, any of the first energy storage module 141 and the second energy storage module 142 may have a battery configuration to utilize any of high-powered battery and high-capacity battery packs. For example, the first energy storage module 141 and the second energy storage module 142 may have different configurations in power and/or capacity. In some examples, the second energy storage module 142 includes a battery pack of capacity of 2 Wh or more. In another example, the second energy storage module 142 includes a battery pack of capacity of 2 kWh or more. In another example, the second energy storage module 142 includes a battery pack of capacity of 4 kWh or more. In another example, a second energy storage module 142 includes a battery pack of capacity of 15 kWh or more. In another example, a second energy storage module 142 includes a battery pack of capacity of 30 kWh or more. In another example, a second energy storage module 142 includes a battery pack of capacity of 60 kWh or more. In another example, a second energy storage module 142 includes a battery pack of capacity of 90 kWh or more. In another example, a second energy storage module may be in a modular form accommodating a combination of a plurality of battery packs where the total capacity amounts to the sum of any or all of the combination. In another example, a second energy storage module 142 may be a combination of a plurality of second energy storage modules where the total capacity amounts to the sum of any or all of the combination.

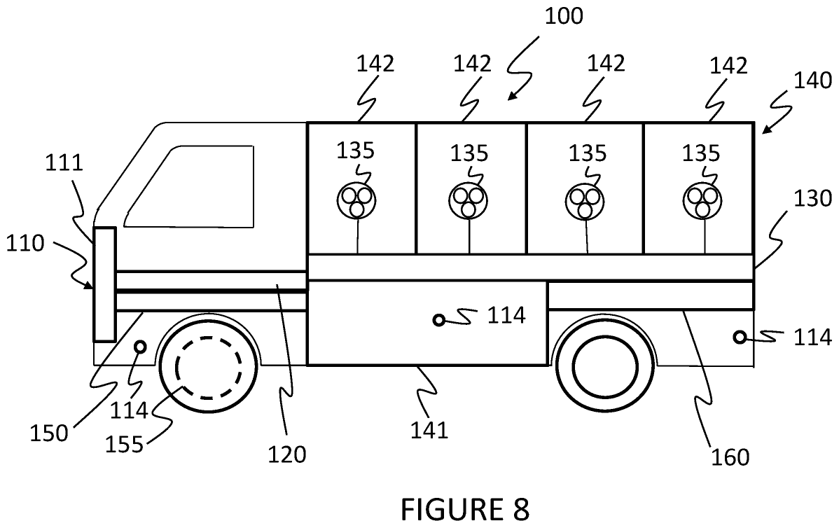

In an exemplary embodiment, the first energy storage module 141 may have a battery configuration different from the battery arrangement of the second energy storage module 142, depending on type or use of the transportation vehicle 100. In certain aspects, the first energy storage module 141 may be configured to produce a higher electric energy output than the electric energy output of the second energy storage module 142 or vice versa. In another aspect, the second energy storage module 142 may have a battery configuration to contain a higher energy capacity than the energy capacity of the first energy storage module 141. In another exemplary embodiment, the second energy storage module 142 may be configured to contain a rechargeable battery pack in a replaceable form for swapping with a compatible rechargeable battery pack of the electric vehicle 200. In certain aspects, the second energy storage module 142 may contain a rechargeable battery pack in a removable modular form. As shown in FIG. 8, the second energy storage module 142 may be configured to contain a plurality of rechargeable battery pack units, where each of the rechargeable battery pack unit is connected with each of the plurality of energy transfer units 135. In some examples, the power distribution unit 150 may be configured to utilize at least one rechargeable battery pack unit in the second energy storage module 142 to power the transportation vehicle for the locomotive motion. In some aspects, the power distribution unit 150 may be configured to charge at least one rechargeable battery pack in the seconder energy storage module 142.

Artificial Neural Network (ANN) is a statistical learning algorithm inspired by the neural network of biology in machine learning and cognitive science, where artificial neurons (nodes) formed by combining synapses learn through synapses. Machine learning technology is a technology that collects and learns a large amount of information based on at least one algorithm, and determines and predicts information based on the learned information. The learning of information is an operation of grasping characteristics, rules, and judgment criteria of information, quantifying a relationship between information, and predicting new data using the quantized pattern. In some examples, the transfer monitoring unit 160 may utilize an artificial neural network to collect and analyze demand data for a period of time by charging or discharging the battery; and update a parameter of the artificial neural network based on the collected date; and train the artificial neural network to determine an optimum charging condition.

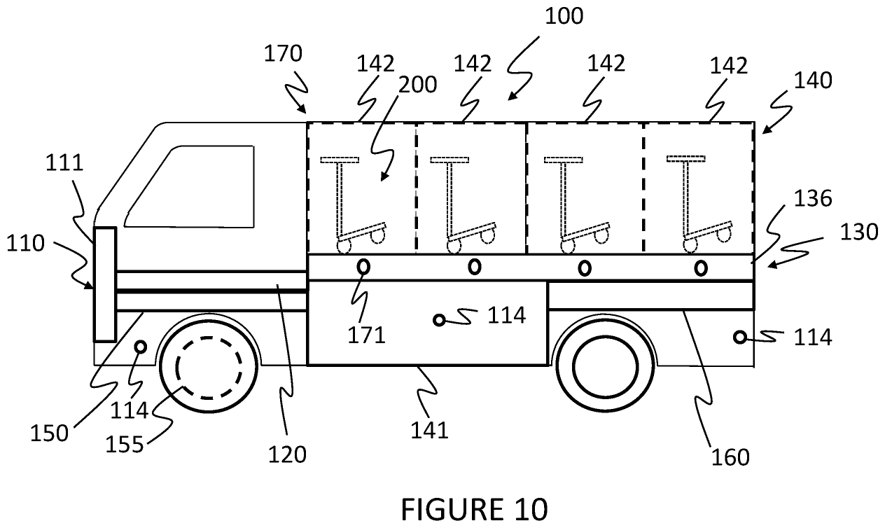

The docking unit 170 may be configured to accommodate a plurality of electric vehicles 200. FIG. 9 shows an exemplary transportation vehicle 100 with the docking unit 170. The docking unit 170 may be externally disposed on the transportation vehicle 100. In certain aspects, the docking unit 170 can be located within the transportation vehicle 100. In some examples, the docking unit 170 may be electronically connected to the EV charging unit 130 to facilitate wireless charging of the electric vehicles 200. In some examples, the docking unit 170 may have a plurality of location identifiers so that each of the plurality of electric vehicles 200 is assigned to a location according to the location identifier 171 and thereby the plurality of electric vehicles 200 can be spatially arranged in the docking unit 170. In some aspect, the location identification may be communicated with the electric vehicle 200 via the communication unit 120 as supply/demand information. FIG. 10 illustrates a plurality of electric vehicles 200 spatially arranged according to the location identifications within the transportation vehicle 100 with the location identifiers 171.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

The above-described embodiments are merely exemplary illustrations of implementations set forth for a clear understanding of the principles of the disclosure. The exemplary embodiments are only examples, and are not intended to limit the scope, applicability, or configuration of the disclosure in any way. While exemplary embodiments have been presented in the foregoing detailed description, it should be appreciated that a vast number of variations exist. Variations, modifications, and combinations may be made to the above-described embodiments without departing from the scope of the claims. For example, various changes can be made in the function and arrangement of elements without departing from the scope of the disclosure as set forth in the appended claims and the legal equivalents thereof all such variations, modifications, and combinations are included herein by the scope of this disclosure and the following claims.

We claim:

1. An energy transport system configured to electrically charge one or more electric vehicles, comprising:
a transportation vehicle including a drive control unit and a power distribution unit;
an electric vehicle (EV) charging unit; and
an energy storage unit,
wherein the energy storage unit is configured to connect with the transportation vehicle,
wherein the EV charging unit is configured to connect with the transportation vehicle,
wherein the EV charging unit is configured to detachably connect with the energy storage unit.

2. The energy transport system according to claim 1, wherein the energy storage unit is configured to at least electrically connect with the power distribution unit, wherein the energy storage unit is configured to connect with the EV charging unit, wherein the energy storage unit is configured to connect with a first energy storage module and a second energy storage module, wherein the first energy storage module is configured to store at least one energy source comprising any of hydrogen and one or more first electric rechargeable batteries to produce first electric energy, wherein the second energy storage module comprises one or more second rechargeable batteries to produce second electric energy, wherein the second energy storage module is separate from the first energy storage module, wherein the power distribution unit is configured to connect with the first energy storage module, wherein the power distribution unit is configured to convert the at least one energy source to the first electric energy at least in part to power the transportation vehicle for locomotive motion, wherein the power distribution unit is configured to connect with the EV charging unit to supply the first electric energy to the EV charging unit, and/or wherein the EV charging unit is configured to selectively transfer any of the first electric energy and the second electric energy to the one or more electric vehicles.

3. The energy transport system according to claim 2, wherein the power distribution unit is configured to convert hydrogen to the first electric energy.

4. The energy transport system according to claim 2, wherein the first energy storage module has a battery arrangement different from a battery arrangement of the second energy storage module.

5. The energy transport system according to claim 2, wherein the second energy storage module is configured to detachably connect with the transportation vehicle.

6. The energy transport system according to claim 1, wherein the transportation vehicle further comprises a communication unit.

7. The energy transport system according to claim 6, wherein the communication unit is configured to transmit and/or receive communication signals, the communication signals being any or any combination of global positioning satellite (GPS) signals, radio frequency identification (RFID) signals, infrared radiation (IR) signals, Bluetooth signals and near field communication (NFC) signals, and radio frequency signals in a range of from 300 Hz to 300 GHz.

8. The energy transport system according to claim 1, wherein the drive control unit is configured to connect with the power distribution unit.

9. The energy transport system according to claim 1, wherein the drive control unit is configured to carry out any of manned or unmanned autonomous driving of the transportation vehicle.

10. The energy transport system according to claim 1, wherein the EV charging unit is configured to carry out autonomous energy transfer to the one or more electric vehicles.

11. The energy transport system according to claim 6, further comprising an energy monitoring unit, wherein the energy monitoring unit is connected to the communication unit and to the energy unit and configured to monitor an energy level of any of the first energy storage module and the second energy storage module.

12. The energy transport system according to claim 11, wherein the energy monitoring unit comprises a data processor operatively coupled with a memory configured to process demand information comprising any of a vehicle identifier of the transportation vehicle, a vehicle identifier of any of the one or more electric vehicles, a pre-determined charge state of any of the one or more electric vehicles, a location of the transportation vehicle, a location of any of the one or more electric vehicle, a distance from the location of the transportation vehicle to the location of any of the one or more electric vehicles, a desired route to any of the one or more electric vehicles from the transportation vehicle, a desired route to the transportation vehicle from any of the one or more electric vehicles, an actual charge state of any of the one or more electric vehicle, a determined amount of electric energy for charging, a duration time for charging to fulfill the determined amount of electric energy; an appointed time for charging, a type of available charging method of the transportation vehicle, a destination for charging, and/or a desired charging/supply price.

13. The energy transport system according to claim 1, further comprising:
a docking unit, wherein the docking unit is connected to the transportation vehicle, wherein the docking unit is configured to accommodate the one or more electric vehicles, and/or wherein the docking unit is configured to electrically connect with the EV charging unit.

14. The energy transport system according to claim 1, wherein the driving unit is configured to carry out full autonomous driving of the transportation vehicle for electrical contact with the one or more electric vehicles for charging once a physical distance between the transportation vehicle and any of the one or more electric vehicles is at or less than a pre-determined distance.

15. The energy transport system according to claim 1, further comprising:
a plurality of transportation vehicles, wherein the plurality of transportation vehicles are configured to establish battery connections in series, parallel, or a combination of serials and parallel with each other.

16. The energy transport system according to claim 2, wherein the first energy storage module is configured to store hydrogen.

17. The energy transport system according to claim 2 wherein the EV charging unit is configured to control and regulate any of the first electric energy and the second electric energy with one or more power converters.

18. The energy transport system according to claim 1, wherein the EV charging unit is configured to carry out wireless energy transfer.

19. The energy transport system according to claim 5, wherein any of the second energy storage module and the EV charging unit is configured to connect with a transportation means separate from the transportation vehicle while being driven by the transportation vehicle.

20. The energy transport system according to claim 12, further comprising an external control center configured to process the demand information from the electric vehicle and any information from the communication unit.
